(19) United States
(12) Patent Application Publication
(10) Pub. No.: US 2005/0165932 A1
(43) Pub. Date: Jul. 28, 2005

(54) Redirecting client connection requests among sockets providing a same service

(75) Inventors: Dwip N. Banerjee, Austin, TX (US); Lilian Sylvia Fernandes, Austin, TX (US); Vasu Vallabhaneni, Austin, TX (US); Venkat Venkatsubra, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/763,100

(22) Filed: Jan. 22, 2004

(51) Int. Cl. G06F 15/173

(52) U.S. Cl. 709/226

(57) ABSTRACT

A method, system, and program for redirecting client connection requests among sockets providing a same service are provided. An application requests multiple sockets from a kernel. In addition, the application generates a socket call option to bind the sockets to a particular port number and passes a list of the sockets to the kernel, where the list indicates that the sockets will all provide access to server systems providing the same service. In response, the kernel sets up the sockets, bound to the same port, and set to reference one another. Then, when a connection request is received for a first socket in the list with a queue that is full, the kernel redirects the connection request to a second socket in the list with available queue space. Thus, rather than drop the connection request from the first socket when it lacks available queue space, the connection request is redirected to another socket providing access to the same service.

### BACKGROUND OF THE INVENTION

1. Technical Field

The present invention relates in general to improved load balancing in network systems and in particular to improved load distribution in a multiple server environment where a cluster of servers provide the same service. Still more particularly, the present invention relates to redirecting client connection requests at the socket layer among a cluster of servers providing the same service when one of the socket's incoming connection queues is full.

2. Description of the Related Art

A server system accessible via a network typically provides access for client systems to data and services. Often, in network environments, a server system will receive multiple simultaneous requests for access to data and services from multiple client systems. Further, the same server system may experience other time periods with few, if any, requests received from client systems. Thus, an important feature of server systems is an ability to handle varying loads.

One of the methods for enabling server systems to handle large loads is through the use of clusters of server systems, where each server system in the cluster provides the same service. In a typical system, one application server will spawn a number of slave application servers to handle incoming connection requests for the same service as is provided by the first application server. To coordinate handling the connection request, each slave server may be assigned to a socket within the socket layer of a network architecture. Typically, each socket has a fixed size queue for holding connection requests received at the socket, but not yet sent to the corresponding slave server.

The drawback to the current cluster load distribution, however, is while the slave servers are available to provide the same services, the load of requests for the service are not efficiently distributed. In particular, the sockets associated with the slave server do not know about each other and therefore load balancing is not performed at the socket layer. For example, consider two sockets associated with servers providing the same service. One socket is assigned IP address IPA, Port X and the other is assigned to IPB, Port Y. While there are multiple sockets available to direct connection requests for a particular service, requests received for the socket assigned to IPA, Port X are only directed to that socket. If the socket queue for IPA, Port X is full and that socket receives a new connection request, the socket silently discards the connection request. This behavior is wasteful in a cluster system, particularly where other socket queues, such as the socket queue for IPB, Port Y are not fully loaded.

Therefore, it would be advantageous to provide a method, system, and program for more efficient load sharing of incoming requests between multiple servers providing the same service. In particular, there is a need for a method, system, and program to enable an application server setting up slave servers which provide the same service to inform the request dispatcher at the socket layer which sockets are associated with slave servers providing the same service, such that requests may be redirected among the related sockets.

### SUMMARY OF THE INVENTION

Therefore, the present invention provides improved load balancing in network systems. In particular, the present invention provides a method, system, and program for load distribution in a multiple server environment where a cluster of servers provides the same service. Further, the present invention provides a method, system, and program for redirecting client connection requests at the socket layer among a cluster of servers providing the same service.

According to a first embodiment, an application requests that a kernel provide multiple sockets. Then, the application generates a socket call option to bind the sockets to a particular port number. In addition, the application may pass a list of the sockets to the kernel, wherein the list indicates that the sockets reference one another. Finally, the application assigns each of the sockets to one of the slave servers spawned by the application to provide a same particular service.

According to second embodiment, a kernel receives, from an application server setting up multiple servers to provide a same service, a socket option call with a list of sockets for informing the operating system kernel that all of the sockets in the list of sockets provide a same service and should be bound to the same port number. In response to the socket option call, the kernel sets up all of the sockets in the list to reference one another and bind to the same port number. Then, responsive to an incoming connection request for a first socket from the list of sockets that is full, the kernel redirects the connection request to a second socket in the list of sockets which is not full. Alternatively, if all of the socket queues are full, then the incoming connection request is dropped.

According to one aspect of the invention, the application server may set up multiple servers in a master-slave configuration. In addition, other cluster server configurations may be implemented.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a distributed network system for facilitating distribution of client requests to servers in accordance with the present invention;

FIG. 3 is a block diagram depicting a multiple server environment in which client connection requests are internally redirected to alternate sockets in accordance with the method, system, and program of the present invention;

FIG. 4 is a high level logic flowchart depicting a process and program for setting up sockets by a master application server in accordance with the method, system, and program of the present invention; and

FIG. 5 is a high level logic flowchart depicting a process and program for handling a new connection request at the socket layer in accordance with the method, system, and program of the present invention.

### DETAILED DESCRIPTION OF THE PREFERRED EMBODIMENT

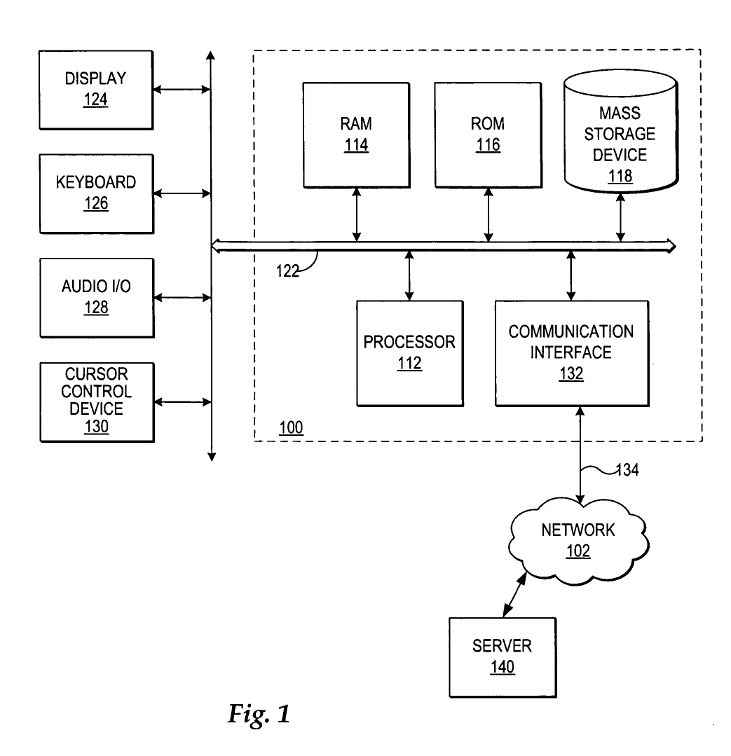

Referring now to the drawings and in particular to FIG. 1, there is depicted one embodiment of a system through which the present method, system, and program may be implemented. The present invention may be executed in a variety of systems, including a variety of computing systems and electronic devices.

Computer system 100 includes a bus 122 or other communication device for communicating information within computer system 100, and at least one processing device such as processor 112, coupled to bus 122 for processing information. Bus 122 preferably includes low-latency and higher latency paths that are connected by bridges and adapters and controlled within computer system 100 by multiple bus controllers. When implemented as a server system, computer system 100 typically includes multiple processors designed to improve network servicing power.

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system preferably provides a graphical user interface (GUI) to the user. In a preferred embodiment, application software contains machine executable instructions that when executed on processor 112 carry out the operations depicted in the flowcharts of FIGS. 5, 6, and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote computer such as a server 140 to requesting computer system 100 by way of data signals embodied in a carrier wave or other propagation medium via a network link 134 (e.g. a modem or network connection) to a communications interface 132 coupled to bus 122. Communications interface 132 provides a two-way data communications coupling to network link 134 that may be connected, for example, to a local area network (LAN), wide area network (WAN), or directly to an Internet Service Provider (ISP). In particular, network link 134 may provide wired and/or wireless network communications to one or more networks.

Communication interface 132 ultimately interfaces with network 102. Network 102 may refer to the worldwide collection of networks and gateways that use a particular protocol, such as Transmission Control Protocol (TCP) and Internet Protocol (IP), to communicate with one another. Both network link 134 and network 102 use electrical, electromagnetic, or optical signals that carry digital data streams. The signals through the various networks and the signals on network link 134 and through communication interface 132, which carry the digital data to and from computer system 100, are exemplary forms of carrier waves transporting the information.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

In addition, computer system 100 typically includes multiple peripheral components that facilitate communication. These peripheral components are connected to multiple controllers, adapters, and expansion slots coupled to one of the multiple levels of bus 122. For example, an audio input/output (I/O) device 128 is connectively enabled on bus 122 for controlling audio inputs and outputs. A display device 124 is also connectively enabled on bus 122 for providing visual, tactile or other graphical representation formats and a cursor control device 130 is connectively enabled on bus 122 for controlling the location of a pointer within display device 124. A keyboard 126 is connectively enabled on bus 122 as an interface for user inputs to computer system 100. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention. In particular, the telephone devices described throughout may be implemented with only portions of the components described for computer system 100.

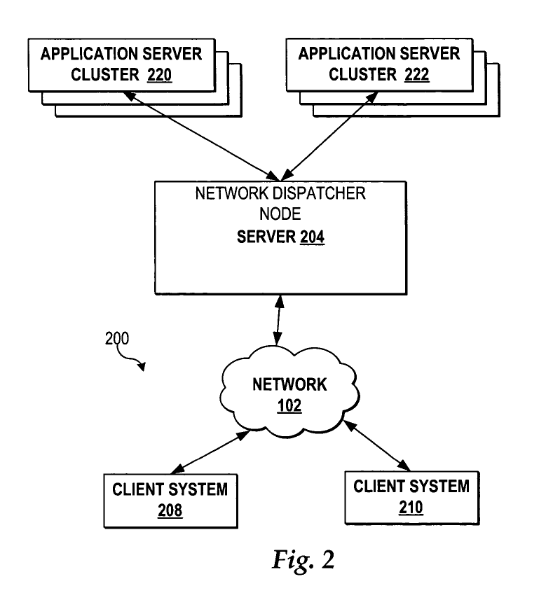

With reference now to FIG. 2, a block diagram depicts a distributed network system for facilitating distribution of client requests to servers in accordance with the present invention. Distributed data processing system 200 is a network of computers in one embodiment of the invention may be implemented. It will be understood that the present invention may be implemented in other embodiments of systems enabled to communicate via a connection.

In the embodiment, distributed data processing system 200 contains network 102, which is the medium used to provide communications links between various devices and computers connected together within distributed data processing system 200. Network 102 may include permanent connections such as wire or fiber optics cables, temporary connections made through telephone connections and wireless transmission connections.

In the depicted example, server 204 is connected to network 102. In addition, client systems 208 and 210 are connected to network 102 and provide a user interface through input/output (I/O) devices. Server 204 preferably provides a service, including access to applications and data, to client systems 208 and 210.

The client/server environment of distributed data processing system 200 is implemented within many network architectures. In one example, distributed data processing system 100 is the Internet with network 102 representing a worldwide collection of networks and gateways that use the TCP/IP suite of protocols to communicate with one another. The Internet is enabled by millions of high-speed data communication lines between major nodes or host computers. In another example, distributed data processing system 200 is implemented as an intranet, a local area network (LAN), or a wide area network (WAN). Moreover, distributed data processing system 200 may be implemented in networks employing alternatives to a traditional client/server environment, such as a grid computing environment.

Within distributed data processing system 200, each of client systems 208 and 210 and server 204 may function as both a “client” and a “server” and may be implemented utilizing a computer system such as computer system 100 of FIG. 1. Further, while the present invention is described with emphasis upon server 204 providing services, the present invention may also be performed by clients 208 and 210 engaged in peer-to-peer network communications and downloading via network 102.

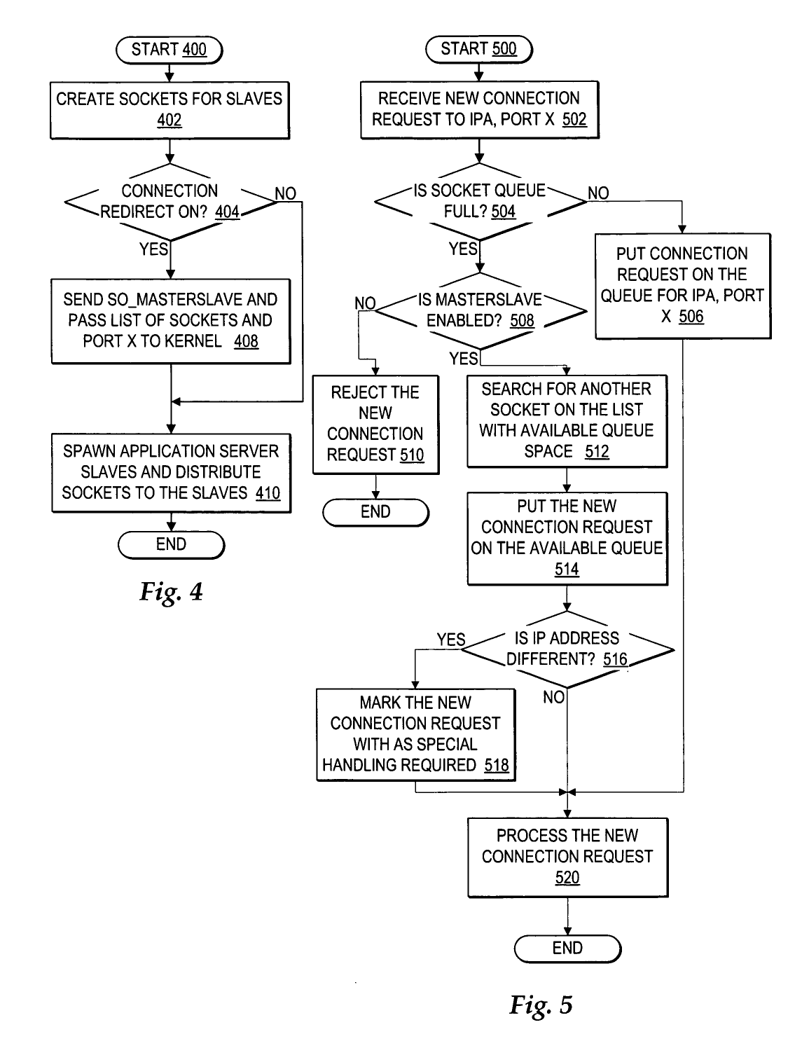

Server 204 may receive multiple simultaneous communication requests to access the same application or resource from multiple client systems, such as client systems 208 and 210. In the example depicted, server 204 may be viewed as a network dispatcher node that creates the illusion of being just one server by grouping systems together to belong to a single, virtual server. In reality, server 204 is a network dispatcher node that controls the actual distribution of requests to multiple server clusters, such as application server clusters 220 and 222. It will be understood that network dispatcher node may distribute requests to multiple types of servers and server clusters, such as web servers. Further, as will be described in FIG. 4, it will be understood that network dispatcher node may be implemented by the operating system kernel layer of a network architecture and thus may be located on multiple servers or on other levels of servers, such as an application server within an application server cluster.

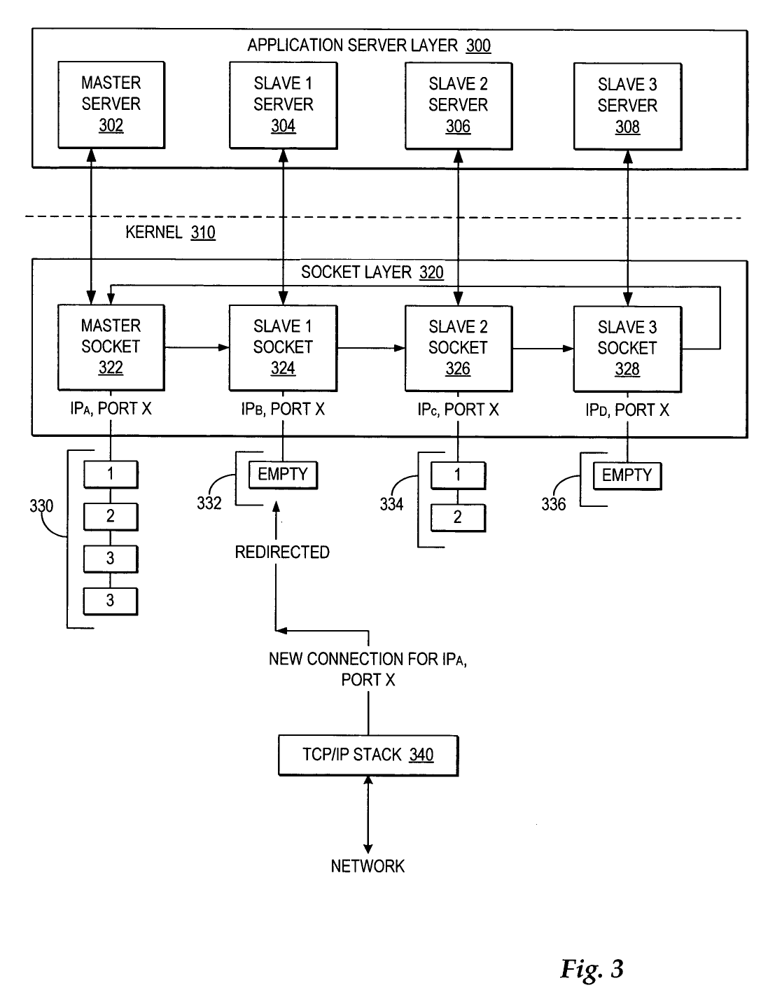

With reference now to FIG. 3, there is depicted a block diagram of a multiple server environment in which client connection requests are internally redirected to alternate sockets in accordance with the method, system, and program of the present invention. As illustrated, an application layer 300, a socket layer 320, and a TCP/IP stack layer 340 of a network architecture interact to process client requests. In addition, although not depicted, an additional device layer may intersect TCP/IP stack layer 330 and the network connection. It will be understood that the architecture depicted is for purposes of illustration and not a limitation on the architectural layers that may be implemented when applying the present invention.

In the architecture depicted, socket layer 320 and TCP/IP stack layer 340 are included in an operating system kernel 310. Although not depicted, a network dispatcher, such as the network dispatcher node of FIG. 2, may be implemented by operating system kernel 310. In particular, the present invention is advantageous because it instructs the network dispatcher node how to redistribute client requests among the available sockets when a requested connection queue is full, rather than allowing the network dispatcher to reject the connection requests.

Application layer 300 includes a cluster of application servers that each provide the same services. The servers of application layer 300 read from and write to the sockets managed by socket layer 320.

In particular, application layer 300 includes a master server 302. Master server 302 is preferably enabled to spawn the additional slave servers depicted within application layer 300 to handle incoming connection requests for the same services provided by master server 302. It will be understood that while the present embodiment is described with reference to a master-slave configuration, other types of cluster configurations may be implemented. Further, it will be understood that in addition to application layer 300, the present invention, as described in detail below, may be implemented in coordination with other layers of the network architecture.

In setting up slave servers 304, 306, and 308, master server 302 first establishes a corresponding socket for each slave server in a socket layer 320. In the example, master server 302 requests sockets 324, 326, and 328 from operating system kernel 310 in socket layer 320. It will be understood that multiple sets of servers may interact with kernel 310 to request sockets in socket layer 320.

According to an advantage of the present invention, master server 302 may select a socket call option to set the selection of sockets to internally reference one another at the socket layer. In particular, master server 302 sends a socket option call to the kernel and passes a list of the sockets and the port number of the service being provided by these sockets into the kernel with the call. While in the embodiment depicted, the socket option call is SO_MASTERSLAVE, it will be understood that this socket option call may be implemented with other names.

Next, the kernel handles the socket option call SO_MASTERSLAVE by setting a SO_MASTERSLAVE flag in each of sockets 322, 324, 326, and 328. By setting the SO_MASTERSLAVE flag, each socket is designated as a socket to which connection requests can be redirected. It will be understood that while the SO_MASTERSLAVE flag is set in the present embodiment, in alternate embodiments other types of flags may be implemented that designate which sockets will reference other sockets.

The arrangement of sockets 322, 324, 326, and 328 within socket layer 320 illustrates the list of sockets passed from master server 302 to kernel 310. In particular, arrows directed from each of the sockets to another socket indicate the order in which the sockets reference one another as specified in the list of sockets. The kernel creates this arrangement list from the list of sockets passed from master server 302 to kernel 310.

Importantly, the sockets set-up to reference one another are all bound to the same port number, as requested by master server 302, since each will be linked with a slave server providing a same set of services. Not all the sockets, however, will be bound to the same IP address. As illustrated in the example, each of the sockets is assigned to listen to port X, however a different IP address is assigned to each socket. In an alternate embodiment, some sockets may reference the same IP address and port, while other sockets reference different IP addresses, but the same port.

Once the sockets are established as referencing one another, then master server 302 spawns the slave servers 304, 306, and 308 and distributes sockets 324, 326, and 328 to the associated slave servers.

Each socket includes a socket queue for holding incoming requests. Typically, each queue is set to hold a maximum of N requests where in the example depicted, queues 330, 332, 334, and 336 are set to hold a maximum of 4 requests.

When a new connection request is received at TCP/IP stack 340, the new connection request is forwarded to socket layer 320 specified with the IP address and port number requested. In the example, the new connection request for IPA, Port X would traditionally be added to queue 330 for socket 322. In the example, however, queue 330 is full with four requests already pending. Kernel 310 will typically set a size limit for each socket queue and discard requests received at a socket if the socket queue is already full.

According to an advantage of the present invention, however, as long as the SO_MASTERSLAVE is enabled for socket 322, kernel 310 looks for another socket in the list of sockets with available queue space and redirects the new connection request to the next available socket queue. In the example, the next socket in the list with available queue space is queue 332 for socket 324. Other available queues, in addition, are queues 334 and 336.

In particular, when kernel 310 redirects connection requests to other sockets providing the same service, different types of load balancing decision rules may be implemented. In the example depicted, kernel 310 picked the alternate socket with the next available queue space. In another example, however, kernel 310 may pick the alternate socket with the smallest incoming connection queue to provide a faster response time to the client. In yet another example, kernel 310 may round robin between all other alternate sockets to load balance the incoming connections between the sockets on the list. In particular, kernel 310 may first determine which sockets are available and pass the list to a network dispatcher node which then determines which socket will receive the redirected request.

Referring now to FIG. 4, there is depicted a high level logic flowchart of a process and program for setting up sockets by a master application server in accordance with the method, system, and program of the present invention. As illustrated, the process starts at block 400 and thereafter proceeds to block 402. Block 402 depicts creating a number of sockets for the number of slave application servers to be called by the master application server. In particular, the application server preferably requests creation of a particular number of sockets and passes the request to the operating system kernel. Next, block 404 depicts a determination of whether a connection redirect is on. If the connection redirect is not on, then the process passes to block 410, as will be further described. If the connection redirect is on, then the process passes to block 408. Block depicts sending the SO_MASTERSLAVE socket option call and passing the list of sockets and port X designation to the kernel. The list of sockets designates the sockets which all perform the same service. Port X is the port that all the sockets are directed to listen on. It will be understood that the “X” of port X could be any of value representing an available port. Thereafter, block 410 depicts spawning the application server slaves and distributing the sockets to the slaves, and the process ends.

With reference now to FIG. 5, there is depicted a high level logic flowchart of a process and program for handling a new connection request at the socket layer in accordance with the method, system, and program of the present invention. As illustrated, the process starts at block 500 and thereafter proceeds to block 502. Block 502 depicts receiving a new connection request to IPA, Port X (or another IP address of a socket assigned to Port X), and the process passes to block 504.

Block 504 depicts a determination whether the socket queue is full for the socket assigned to IPA, Port X. If the socket queue is not full, then the process passes to block 506. Block 506 depicts putting the connection request on the queue for the socket with IPA, Port X, and the process passes to block 520. Alternatively, at block 504, if the socket queue is full, then the process passes to block 508.

Block 508 depicts a determination whether SO_MASTERSLAVE is enabled for the socket. If SO_MASTERSLAVE is not enabled, then the process passes to block 510. Block 510 depicts rejecting the new connection request, and the process ends. Alternatively, at block 508, if SO_MASTERSLAVE is enabled for the socket, then the process passes to block 512.

Block 512 depicts searching for another socket on the list that has available queue space. Although not depicted, if no socket has available queue space, then the request may be discarded. However, once another socket on the list with available queue space is located, block 514 depicts putting the new connection request on the available queue. Thereafter block 516 depicts a determination whether the IP address of the available socket queue is different from the IP address originally called. If the IP addresses are different, then the process passes to block 518. Block 518 depicts marking the new connection request as requiring special handling, and the process passes to block 520. Alternatively, at block 516 if the IP addresses are not different, then the process passes to block 520. Block 520 depicts processing the new connection request, and the process ends. If the special handling flag is set for a new connection request, then when the corresponding application server accepts the request from the socket, following with the example, a socket with IP address IPA is cloned and sent up to the application server when the new connection request is processed, even though the connection request was waiting on a socket with local address IPB.

While the invention has been particularly shown and described with reference to a preferred embodiment, it will be understood by those skilled in the art that various changes in form and detail may be made therein without departing from the spirit and scope of the invention.

1. A method for redirecting connection requests at an operating system kernel level comprising:
receiving, from an application setting up a cluster of servers providing a same service, a socket option call with a list of sockets for informing an operating system kernel that all of the sockets in said list of sockets will provide said same service;
setting up all of said sockets in said list of sockets to reference each other in said operating system kernel; and
responsive to receiving an incoming connection request for a first socket from said list of sockets that is full, redirecting said connection request to a second socket in said list of sockets that is not full, such that said operating system kernel redirects said connection request to said second socket providing said same service as said first socket.

2. The method according to claim 1 for redirecting connection requests further comprising:
responsive to receiving said incoming connection request for said first socket and all of said sockets in said list of sockets are full, dropping said connection request.

3. The method according to claim 1 for redirecting connection requests further comprising:
responsive to receiving said socket option call, binding all of said sockets in said list of sockets to a same port number.

4. The method according to claim 1 for redirecting connection requests wherein each of said sockets in said list of sockets is distributed among said cluster of servers providing said same service.

5. The method according to claim 1 for redirecting connection requests wherein said cluster of servers implements a master-server configuration.

6. The method according to claim 1 for redirecting connection requests further comprising:
binding all of said sockets in said list of sockets to a different internet protocol address; and
responsive to redirecting said incoming connection request from said first socket to said second socket, replacing a requested internet protocol address to which said first socket is bound with a replacement internet protocol address to which said second socket is bound.

7. A system for redirecting connection requests at an operating system kernel level comprising:
means for receiving, from an application server setting up a master-slave configuration, a socket option call with a list of sockets for informing an operating system kernel that all of the sockets in said list of sockets provide a same service;
means for setting up all of said sockets in said list of sockets to reference each other in said operating system kernel;
means, responsive to receiving an incoming connection request for a first socket from said list of sockets that is full, for redirecting said connection request to a second socket in said list of sockets that is not full.

8. The system according to claim 7 for redirecting connection requests further comprising:
means, responsive to receiving said incoming connection request for said first socket and all of said sockets in said list of sockets are full, for dropping said connection request.

9. The system according to claim 7 for redirecting connection requests further comprising:
means, responsive to receiving said socket option call, for binding all of said sockets in said list of sockets to a same port number.

10. The system according to claim 7 for redirecting connection requests wherein each of said sockets in said list of sockets is distributed among said cluster of servers providing said same service.

11. The system according to claim 7 for redirecting connection requests wherein said cluster of servers implements a master-server configuration.

12. The system according to claim 7 for redirecting connection requests further comprising:
means for binding all of said sockets in said list of sockets to a different internet protocol address; and
means, responsive to redirecting said incoming connection request from said first socket to said second socket, for replacing a requested internet protocol address to which said first socket is bound with a replacement internet protocol address to which said second socket is bound.

13. A computer program product, residing in a computer readable medium, for redirecting connection requests at an operating system kernel level comprising:
means for enabling receipt, from an application server setting up a master-slave configuration, a socket option call with a list of sockets for informing an operating system kernel that all of the sockets in said list of sockets provide a same service;
means for controlling set-up of all of said sockets in said list of sockets to reference each other in said operating system kernel;
means, responsive to receiving an incoming connection request for a first socket from said list of sockets that is full, for enabling redirection of said connection request to a second socket in said list of sockets that is not full.

14. The computer program product according to claim 13 for redirecting connection requests further comprising:
means, responsive to receiving said incoming connection request for said first socket and all of said sockets in said list of sockets are full, for enabling said connection request to be dropped.

15. The computer program product according to claim 13 for redirecting connection requests further comprising:
means, responsive to receiving said socket option call, for enabling binding all of said sockets in said list of sockets to a same port number.

16. The computer program product according to claim 13 for redirecting connection requests further comprising:
means for enabling binding all of said sockets in said list of sockets to a different internet protocol address; and
means, responsive to enabling redirection of said incoming connection request from said first socket to said second socket, for controlling replacement of a requested internet protocol address to which said first socket is bound with a replacement internet protocol address to which said second socket is bound.

17. A method for controlling setup of sockets assigned to a cluster of server systems, comprising:
requesting, by an application, for a kernel to provide a plurality of sockets;
generating a socket call option to bind said plurality of sockets to a particular port number; and
assigning each of said plurality of sockets to one from among a plurality of slave servers spawned by said application to provide a same service, such that said plurality of sockets are setup such that if one socket queue is full when a request is received said request is redirected to another socket providing said same service.

18. A system for controlling setup of sockets assigned to a cluster of server systems, comprising:
means for requesting, by an application, for a kernel to provide a plurality of sockets;
means for generating a socket call option to bind said plurality of sockets to a particular port number; and
means for assigning each of said plurality of sockets to one from among a plurality of slave servers spawned by said application to provide a same service.

19. A computer program product, residing on a computer readable medium, for controlling setup of sockets assigned to a cluster of server systems, comprising:
means for enabling an application to request that a kernel provide a plurality of sockets;
means for generating a socket call option to bind said plurality of sockets to a particular port number; and
means for controlling assignment of each of said plurality of sockets to one from among a plurality of slave servers spawned by said application to provide a same service.
